(19) United States
(12) Patent Application Publication
(10) Pub. No.: US 2025/0124532 A1
(43) Pub. Date: Apr. 17, 2025

(54) METHOD AND APPARATUS FOR MONITORING AND ANALYZING CROWD DYNAMICS, CROWD DENSITY, AND CROWD FLOW

(71) Applicant: Greg Guzzetta, Culver City, CA (US)

(72) Inventor: Greg Guzzetta, Culver City, CA (US)

(21) Appl. No.: 18/919,365

(22) Filed: Oct. 17, 2024

Related U.S. Application Data
(60) Provisional application No. 63/591,029, filed on Oct. 17, 2023.

(51) Int. Cl. G06Q 50/26; G01S 13/89

(52) U.S. Cl. CPC G06Q 50/265; G01S 13/89

(57) ABSTRACT

The system uses LiDAR to determine crowd density analysis and flow. The system places a plurality of sensors and distributes them in an area where a crowd will gather. To create a comprehensive 3D representation of the environment, the LiDAR sensor emits numerous laser pulses in different directions, covering a wide field of view. The sensor collects the returning light for each pulse. The collected data, consisting of distance measurements and their corresponding angles, is processed to create a point cloud. The generated point cloud can be further processed and analyzed to extract various information about the environment.

This patent application claims priority to U.S. Provisional Patent Application 63/591,029 filed on Oct. 17, 2023, which is incorporated by reference herein in its entirety.

### BACKGROUND OF THE SYSTEM

Monitoring and measuring crowd density and dynamics is a vital tool for maintaining public safety at Mass Gatherings. Without effective monitoring, one cannot effectively communicate nor mitigate dangerous crowd behaviors, which far too often lead to tragic injury or death. There have been many instances of injuries and deaths at concerts, sporting events, festivals, and the like.

In addition to safety concerns, there is a desire to accurately measure crowd size for other purposes. For example, there may be a crowd size limit in a certain area of a venue (e.g. mosh pit). It would be beneficial to have a system to determine when the crowd size limit has been reached, so that further entry into that area may be prohibited. In other instances, there may be a limited amount of space for a dynamically changing space (e.g. people trying to get in, and those that are in periodically exiting).

Another reason to accurately measure crowd size and density is revenue tracking. By comparing tickets sold to actual attendance, it is possible to identify possible fraud, unauthorized entries, to prevent potential revenue losses.

It can also be useful for managing the flow of people at an event, such as a convention or some event with multiple paths. It would be useful to identify choke points, high traffic areas, low traffic areas, and crowd flow at different times. This can allow dynamic restructuring of flow paths, location of booths and exits, or the use of temporary barriers at certain times and locations to help avoid crowd flow bottlenecks and risks.

It would be helpful to be able to track the density of a crowd (number of people per unit area, e.g., per square meter). It would also be helpful to track the dynamics of a crowd, e.g., are denser areas forming and flowing. Further, it would be helpful to be able to use the information to help avoid dangerous situations or to alleviate them as soon as possible.

In the prior art, there have been attempts made to monitor crowds. Video analytics including fixed and dynamic hardware has been a popular solution to monitoring crowd density and dynamics for several years. Analytics such as convolutional neural networks (CNN), minimum-redundancy maximum-relevance techniques, multichannel dense grouping modules, improved grouping convolution block, and even particle based methods have been used to improve crowd monitoring beyond what is perceived by the human eye.

Video surveillance is a commonly used method in crowd monitoring and management. However, its performance is greatly affected by environmental conditions. As crowd density increases, the accuracy of video surveillance significantly decreases due to overlapping objects and individuals, making it inaccurate for density estimations. It has been found that video surveillance lacks accuracy above 2.1 persons per square meter. Higher densities cause accuracy to drop significantly.

Infrared sensors have been used for tracking body heat but are vulnerable to interference from ambient heat sources and can struggle to distinguish individual heat signatures in crowded areas. Infrared sensors have been found to provide accuracy only up to approximately 2.5 persons per square meter.

WiFi and/or Bluetooth tracking have been implemented in the prior art. These technologies can track mobile devices in a given area; however, they are limited by device ownership, active status, and signal interference. Furthermore, privacy concerns have been raised due to tracking individuals' devices. Also, there are often people in a crowd without a mobile device available, or it may not be turned on. Even for those using the system, accuracy is limited to approximately 2.2 persons per square meter. Thus, this system is unreliable.

### SUMMARY

The system uses LiDAR to determine crowd density analysis and flow. The system places a plurality of sensors and distributes them in an area where a crowd will gather. To create a comprehensive 3D representation of the environment, the LiDAR sensor emits numerous laser pulses in different directions, covering a wide field of view. The sensor collects the returning light for each pulse. The collected data, consisting of distance measurements and their corresponding angles, is processed to create a point cloud. The generated point cloud can be further processed and analyzed to extract various information about the environment.

### BRIEF DESCRIPTION OF THE DRAWINGS

FIG. 1 is a block diagram of the system in an embodiment.

FIG. 2 is a flow diagram illustrating the operation of the system in an embodiment.

FIG. 3 is a flow diagram illustrating the analysis step in an embodiment of the system

FIG. 4 is a flow diagram illustrating the alignment operation in an embodiment.

FIG. 5 is a flow diagram illustrating LiDAR pipeline operation in an embodiment.

FIG. 6 is a flow diagram illustrating the operations of the object pipeline in an embodiment.

FIG. 7 is an example computer embodiment of the system.

### DETAILED DESCRIPTION OF THE SYSTEM

The system uses LiDAR to determine crowd density analysis and flow. The system places a plurality of sensors and distributes them in an area where a crowd will gather. LiDAR, which stands for “Light Detection and Ranging,” is a remote sensing technology that uses laser light to measure distances and create detailed 3D representations of objects and landscapes. It's commonly used in applications such as autonomous vehicles, forestry, archaeology, urban planning, and more.

The system has been able to track at least 7 persons per square meter with higher reliability and accuracy. This substantial improvement represents a 55.56% increase over video surveillance, a 30% increase over infrared sensors, and a 47.73% increase over Wi-Fi/Bluetooth tracking. Such a dramatic increase in person-per-square-meter tracking capacity is important in the field of crowd density measurement and monitoring. It signifies a far more precise method of monitoring, allowing for safer and better management of dense crowds at large-scale events. The success of this approach opens a pathway for future applications of LiDAR technology in crowd monitoring, paving the way for a safer and more efficient method of managing crowd dynamics.

The system can operate in all environments, from daylight to darkness, and can be used in the presence of environmental obstructions such as smoke and dust. Spotlights, flashing lights, stage lighting, and pyrotechnics do not impact the ability of the system to accurately track crowd density. The system can uniquely identify separate individuals in a crowd and continuously track them and provide a track of their movement over time. This identification is anonymous, with the system simply identifying a figure and assigning a unique ID to allow it to track the figure as desired. The system is capable of tacking footfall, dwell times, and other data useful for analysis.

In operation, a LiDAR sensor emits rapid pulses of laser light towards the target area. The laser emits light in a specific wavelength, usually in the near-infrared range, which is chosen for its safety and ability to interact with various surfaces. When the emitted laser pulse encounters an object or surface, a portion of the light is reflected back toward the LiDAR sensor.

The LiDAR sensor measures the time it takes for the emitted laser pulse to travel to the object and return. Since the speed of light is constant, the sensor can calculate the distance to the object by multiplying the time it took for the light to travel with the speed of light and then dividing by 2 (to account for the round trip).

To create a comprehensive 3D representation of the environment, the LiDAR sensor emits numerous laser pulses in different directions, covering a wide field of view. The sensor collects the returning light for each pulse. The collected data of all of the sensors, consisting of distance measurements and their corresponding angles, is processed to create a point cloud. A point cloud is a set of 3D coordinates (points) that represent the surfaces and objects in the scanned area. Each point in the cloud has coordinates (x, y, z) corresponding to its position in space, and sometimes additional information such as intensity or color can be associated with each point.

The generated point cloud can be further processed and analyzed to extract various information about the environment. This can include creating detailed 3D models, identifying objects, detecting obstacles, measuring terrain elevation, and more.

It should be noted that some LiDAR systems operate with single returns (only one pulse is emitted and received), while others use multiple returns (multiple reflections from different surfaces within the laser's path).

In one embodiment, the system can be used in connection with RFID tags (or other identifying mechanism) to track registered guests. A guest badge includes a tag such as an RFID tag to identify the guest. The system can be used to ensure guests remain in permitted areas and do not stray to secure areas. The system can also be used to trigger environmental changes (lights, HVAC, advertising, and the like) depending on the location of a particular guest.

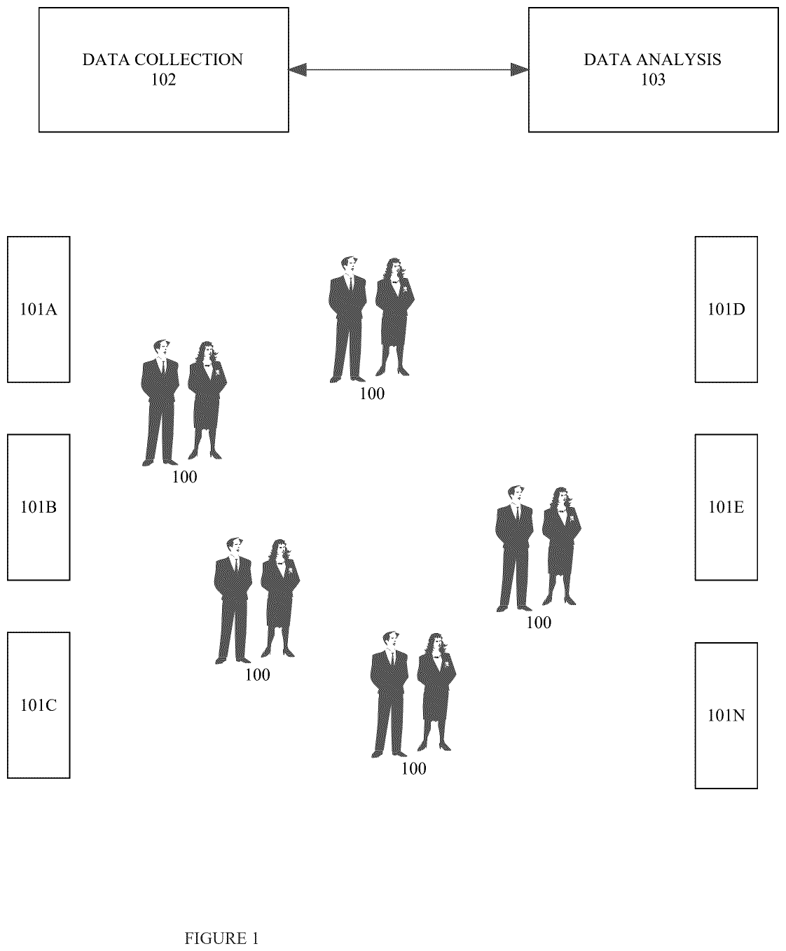

FIG. 1 illustrates an embodiment of the system. The LiDAR sensors 101A-101N are placed around the crowd 100 site at optimized locations. In one embodiment, the sensors are placed at a height and angle to achieve a 45 degree field of View (“FOV”) of the subject people. In one embodiment, the sensors are placed on adjustable brackets to customize the sensors for a particular application. In one embodiment, a variety of sensors can be used with differing FOV. In addition, different FOV may be used for different situations. For example, when the sensor is higher up from the crowd, the FOV may be different than when the sensor is closer to the ground. A smaller FOV can still cover a large area if it is higher up, because it can observe a greater area.

The sensors 101A-101N communicate with a data collection module 102 either directly or wirelessly, or even via the cloud. The data collection module 102 receives the raw data from the sensors and provides it to Data Analysis Module 103. The data is processed to create a point cloud. The Data Analysis Module 103 tracks the density of the crowd continuously. The system also has the ability to identify individuals in the crowd and track their individual movement.

The tracking of an individual does not include identifying information or personal private information (PPI) about the individual. The system assigns a tracking number to each detected individual and can provide a path of that individual through the venue during the tracking. The system tracks position, velocity, direction, and size (volume) of each person in the crowd.

The system determines and reports crowd density based on volumetric data and people count on a per square meter basis. The system compares local density at key points (e.g., at entrances, exits, near a stage, bathrooms, and the like) and provides an alert if the local density exceeds a certain threshold. Density above a certain threshold could present a danger to the individuals there or even nearby, and steps can be taken to reduce the density to a safe number. For example, a density above 3.5 to 5 persons per square meter may be considered to be a risky density. However, the system also tracks dynamic flow, and if the high density region has sufficient flow, which may be considered safe. In addition, the present system also can identify the volume of individuals. Therefore, the density is not just number of persons per square meter, but how much volume per square meter is actually being used. Fewer larger people per square meter could present a similar problem to more small people per square meter.

The system can calculate the correlation of people's position to each other to determine patterns and anomalies, dwell times, and flow rates.

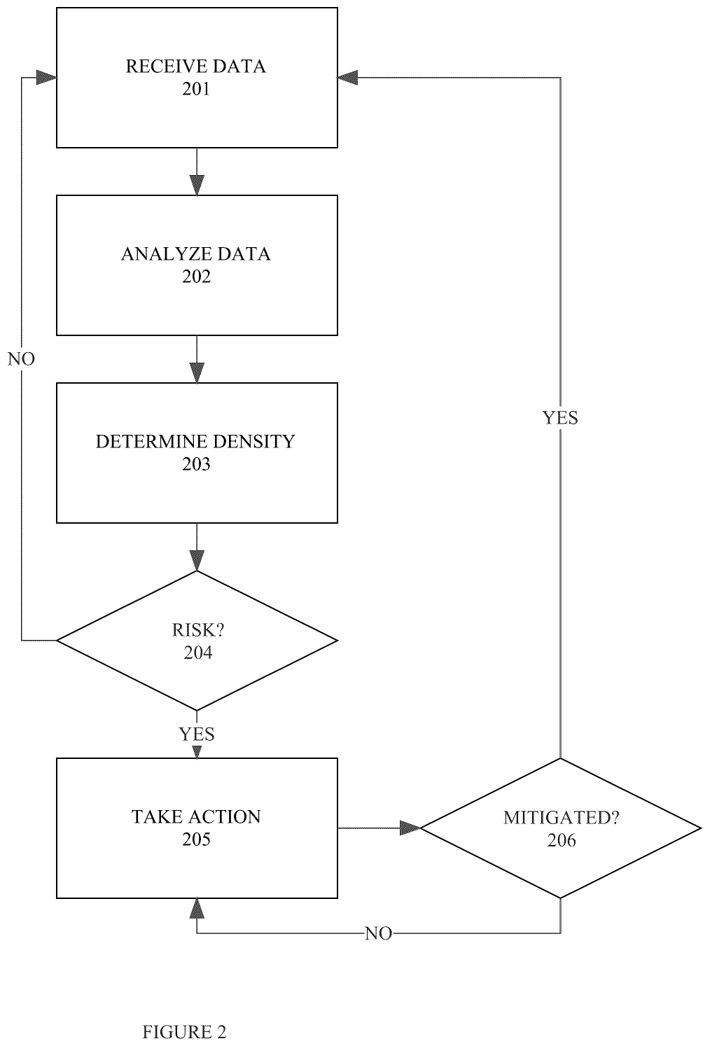

FIG. 2 is a flow diagram illustrating the operation of the system in an embodiment. At step 201 the system (e.g. Data Analysis 103) receives data from the LiDAR sensors. At step 202 the system analyses the data, creating point clouds and identifying individuals. At step 203 the crowd density is determined over the area of interest, looking for areas of high density.

At decision block 204, it is determined if any of the areas have a crowd density that is risky (e.g., above a certain threshold of 5 persons per square meter). If so, the system moves to step 205 and triggers action. The action could involve personnel going to the risky location and dispersing the people to a safer and lower density. It could involve other remedial actions. Such actions can include opening additional exits, pausing a presentation, asking a performer or presenter to ask the crowd to separate. All this can be initiated before the crowd density reaches a dangerous level.

At decision block 206 it is determined if the mitigation steps have succeeded. If not, the system returns to step 205 to continue mitigation actions. If the mitigation steps have succeeded at step 206, or if there is no risk at decision block 204, the system returns to step 201 to repeat the cycle.

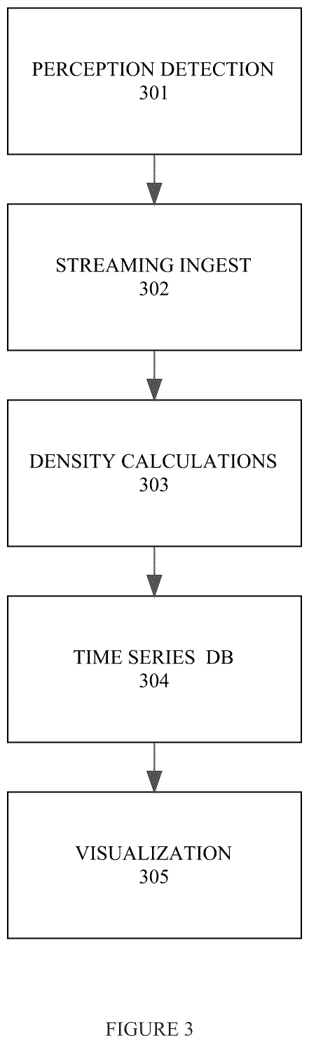

FIG. 3 is a flow diagram illustrating the analysis step in an embodiment of the system. At step 301 the system detects objects using a perception algorithm and a proprietary deep learning algorithm. At this stage the system detects an object, classifies the object, and tracks the object. In one embodiment, the system distinguishes between stationary objects and persons. Each person in the field of view is classified, assigned a unique identification, and continuously tracked through the space of interest. In one embodiment, the system utilize a commercially available perception software suite, such as Ouster Gemini Detect and the like. The output of this step is an object list.

At step 302, the object list is ingested into the system via an event streaming application. Event streaming is the capturing of data in real-time from sources (such as LiDAR sensors) and storing the events for later retrieval, analysis, manipulation, and processing. In one embodiment, the streaming is accomplished by a platform such as Apache Kafka® and the like. In one embodiment, the streaming is a distributed system of servers and clients that communicate using a protocol such as TCP Network Protocol. This step generates a point cloud.

At step 303 the system performs point density calculations. The point density calculation defines the amount of measurements per sample area. The point density calculations can be accomplished using a distributed processing engine such as Apache Flink® and the like.

At step 304 the data is stored in a time series database. A time series database is a storage system that is designed to store and retrieve data records that are part of a times series, which is a set of data points that are associated with timestamps. The timestamps provide context data for continuous flow data such as the kind that comes from sensors such as the LiDAR sensors of the present system. A time series database allows the system to tore large volumes of timestamped data in a format that allows fast insertion and retrieval to support complex analysis.

At step 305, the system performs processing to generate visualization of the data. The system will render the points in XYZ 3D space and use coloring and intensity to highlight features, distinguish persons, and track movement. In one embodiment, the system allows full rotation of the image to further aid an analysis.

In one embodiment, security or other crowd control personnel can be dispatched to high density areas to determine why the high density is occurring and the best way to reduce density in that area.

The system collects valuable data about crowd movement, not just for safety reasons, but for design, commercial, and event planning purposes. The system can identify dwell times of individuals at various locations, indicating higher interest. The crowd movement is examined at entrance and exit to analyze flow paths and to determine if more or fewer doorways or gates could be safely used.

The system can track crowd movement at a convention, mall, store, sporting event, concert, food court, and the like to help identify choke points, wasted space, or other design areas that could be improved.

### Alignment Settings

The system improves the collection of data from the LiDAR sensors by novel settings. The system utilizes Iterative Closest Point (ICP) alignment parameters such as maximum correspondence distance and iterations, to help match points between LiDAR scans. The system improves object identification by using Random Sample Consensus (RANSAC) to identify objects across multiple frames.

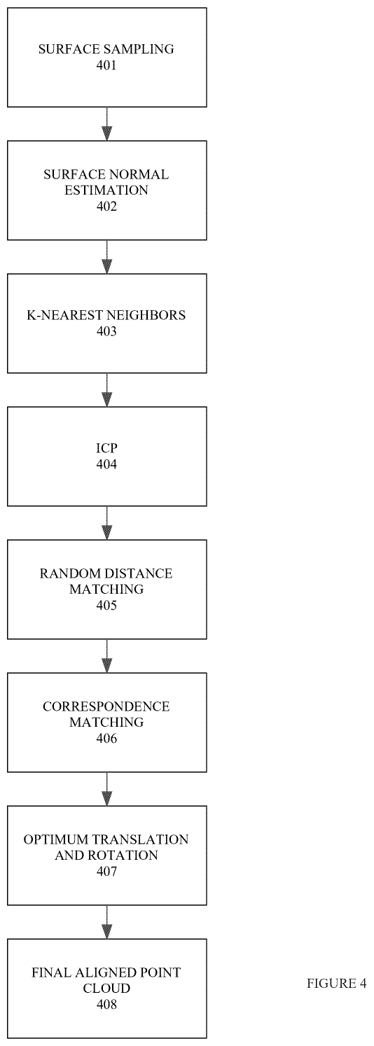

FIG. 4 is a flow diagram illustrating the alignment operation in an embodiment. At step 401 the system scans the surface of the crowd and performs surface normal estimation on some number of nearest neighbors (e.g. 20) at step 402. At step 403 the system performs an ICP on the k nearest neighbors for some maximum number of iterations (e.g. 250). At step 405 the system performs random distance matching and if the minimum difference in error rotation drops below some pre-set value (e.g. 0.003), the system will stop the iterations of step 404.

At step 406 the system performs correspondence matching between iterations for translation error and if the translation error is small enough (e.g., 0.03) the iterations stop. At step 407 the system determines the optimal translation and rotation of the data and the final aligned point cloud is output at step 408.

### LiDAR Pipeline

The LiDAR pipeline Defines processing parameters for background and foreground filtering, clustering, and blockage detection. For example, background filtering is disabled, while foreground filtering is enabled with certain thresholds. Cluster settings and algorithms like PCA (Principal Component Analysis) and DBSCAN (Density-Based Spatial Clustering of Applications with Noise) are used to group LiDAR points into objects.

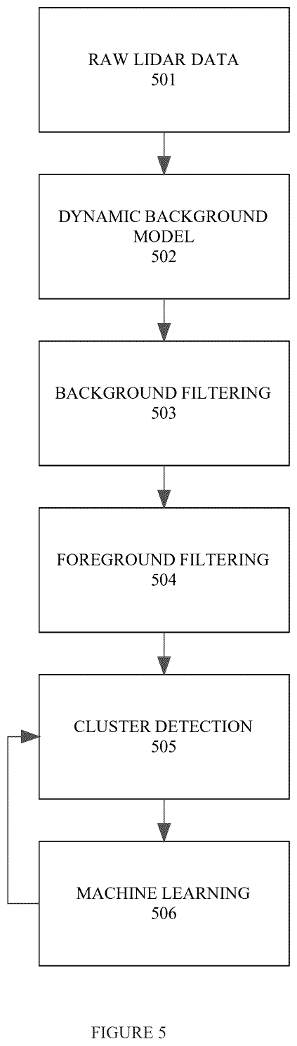

FIG. 5 is a flow diagram illustrating LiDAR pipeline operation in an embodiment. At step 501 the raw LiDAR data is provided to the system. At step 502 the system implements a dynamic background model. This model adapts to changing environments and defines a time frame for background points to fade out if no new returns are detected and how quickly the background points transition to free space after no detections. The dynamic background model allows the acceleration of the fading of free space and allows the rate to double after a certain number of frames (e.g. 4).

At steps 503 and 504 the system performs background filtering and foreground filtering respectively. At step 505 the system does cluster detection, coupling that with machine learning at step 506 to improve performance of cluster detection. In one embodiment, the system does not use cluster downsampling. The system determines a maximum number of points to be involved in a cluster (e.g. 1000) and the minimum number of points required for a cluster to be considered valid (e.g. 7).

Foreground filtering defines range difference and number of neighboring points required for foreground classification.

The machine learning step 506 in an embodiment sues constant frame timestamps for processing and a buffer for detecting the edge of cluster. To aid in processing the machine learning, some parameters are defined so that some data can be ignored. For example, the maximum height for clusters to be processed is 6.6 feet. The system also defined range thresholds (e.g. at least 0.25 and up to 2.5 feet).

### Object Pipeline

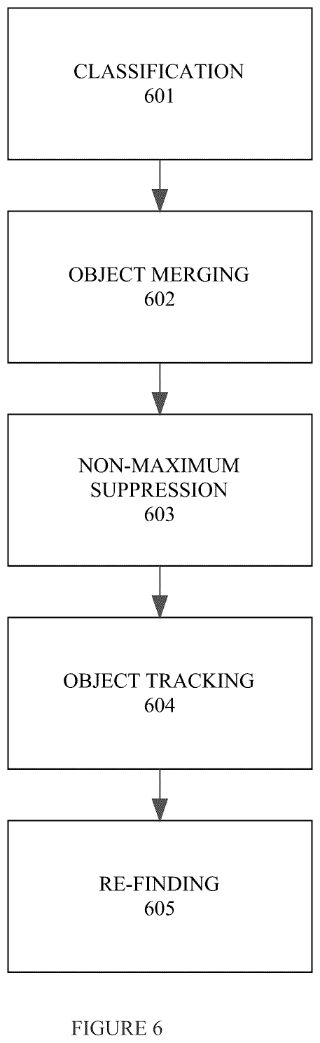

FIG. 6 is a flow diagram illustrating the operations of the object pipeline in an embodiment. The Object Pipeline is responsible for processing the detected objects after the LiDAR data has been clustered and filtered. It includes various algorithms and configurations for object classification, merging, and tracking. The system specifies Gaussian-Bayes parameters for classifying different object types (e.g. people with appropriate height, length, width, and speed parameters), bicycles, vehicles, and the like at step 601. At step 602 the system performs object merging of clusters into one object (and splitting clusters when an object is detected as two separate clusters due to partial occlusion). In one embodiment, at step 603, the system utilizes non-maximum suppression to prevent multiple overlapping detections of the same object by merging them based on spatial and size similarities.

At step 604 the pipeline performs object tracking from frame to frame and over time, using process noise and error variances to model object movement. At step 605, the system performs re-finding operations, for objects that leave the field of view and then return. In one embodiment, this is an optional step.

### Deep Learning.

The system can use one or more of several training models. The system can use Linear Models, Tree-based models, Neural Networks, and/or other models including Support Vector Machines, K-nearest neighbors, Naïve Bayes, Gaussian Process Regression, Extreme Learning Machines, Stochastic Gradient Descent, Bayesian Networks, and the like.

A Deep Neural Network (DNN) is a type of neural network with multiple layers between the input and output layers. These intermediate layers, often called hidden layers, enable the network to model complex relationships in data. Each layer consists of numerous interconnected neurons, or nodes, that process information through weighted connections. The network learns by adjusting these weights during training, typically using a process called backpropagation, which minimizes the error between the network's predictions and actual outcomes. DNNs are particularly powerful for tasks involving large datasets and high-dimensional data, such as image and speech recognition, natural language processing, and autonomous driving, due to their ability to capture intricate patterns and representations in the data.

Hyperplane and Margin: In a binary classification problem, an SVM aims to find a hyperplane that separates the data points of the two classes. The best hyperplane is the one that maximizes the margin, which is the distance between the hyperplane and the nearest data points from each class, known as support vectors.

Support Vectors: These are the critical data points that lie closest to the decision boundary (hyperplane). They aid in defining the position and orientation of the hyperplane. The algorithm focuses on these support vectors to find the optimal hyperplane.

Kernel Trick: SVMs can handle non-linearly separable data by transforming it into a higher-dimensional space using kernel functions. Common kernels include linear, polynomial, radial basis function (RBF), and sigmoid. This transformation allows the SVM to find a hyperplane in the new space that can separate the classes more effectively.

Objective Function: The SVM algorithm seeks to minimize the classification error while maximizing the margin. This is achieved by solving a convex optimization problem, ensuring a global optimum solution.

Soft Margin: In cases where the data is not perfectly separable, SVMs introduce a soft margin that allows some misclassification but penalizes it. This is controlled by a regularization parameter (C), which balances the trade-off between maximizing the margin and minimizing the classification error.

SVMs are known for their robustness and effectiveness, particularly in high-dimensional spaces. They are used in various applications, such as image and text classification, bioinformatics, and finance, due to their ability to handle complex and high-dimensional datasets while providing high accuracy and generalization capabilities.

In one embodiment, the LLM is used for user interface integration, allowing it to facility user interaction through natural language processing (NLP). The LLM also enhances data comprehension and model insights.

Comparative Model Analysis is a systematic approach used in machine learning and statistics to evaluate and compare the performance of different models on a given task. The goal is to determine which model is most suitable for a specific problem based on various criteria, such as accuracy, efficiency, and robustness.

Model Selection: The first step involves selecting the models to be compared. These models can vary in complexity, underlying algorithms, and assumptions. Common choices include linear regression, decision trees, random forests, support vector machines, neural networks, and ensemble methods.

Bagging (Bootstrap Aggregating) involves training multiple models independently on different random subsets of the training data and then aggregating their predictions, often by averaging or voting. Random forests, which aggregate multiple decision trees, are a popular example of bagging.

Boosting focuses on training a sequence of models, each one correcting the errors of its predecessor. Models are trained in series, with more weight given to misclassified instances in subsequent iterations. Gradient boosting machines (GBMs) and AdaBoost are well-known boosting techniques.

Gradient Boosting Machines (GBMs) are a powerful and widely-used ensemble learning technique for both regression and classification tasks. The goal of GBMs is to build a strong predictive model by combining the outputs of several weak models, typically decision trees, in a sequential manner.

Sequential Learning: GBMs build models in a sequence, where each new model aims to correct the errors made by the previous models. This iterative approach focuses on improving the performance of the ensemble by learning from the mistakes of the earlier models.

Weak Learners: The individual models used in GBMs are often simple decision trees, known as weak learners. These trees are typically shallow (having limited depth) to ensure that they do not overfit the data. Each tree is trained to correct the residual errors of the combined ensemble of all previous trees.

Gradient Descent Optimization: The “gradient” in Gradient Boosting refers to the optimization technique used to minimize the loss function. At each iteration, the algorithm calculates the gradient of the loss function with respect to the model's predictions and fits a new tree to this gradient. Essentially, each new tree is constructed to point in the direction that reduces the overall error the most.

Additive Model: The final model in a GBM is an additive combination of all the weak learners. The predictions of each tree are weighted and summed to produce the final output. The contribution of each tree is scaled by a learning rate parameter, which controls how much each new tree influences the overall model.

Regularization: To prevent overfitting, GBMs incorporate various regularization techniques, such as limiting the depth of the trees, using shrinkage (learning rate), and subsampling the data. Regularization helps in making the model more robust and improves its generalization to unseen data.

Loss Functions: GBMs can be applied to different types of problems by choosing appropriate loss functions. For regression, common loss functions include mean squared error (MSE) and mean absolute error (MAE). For classification, loss functions like log-loss or exponential loss are used.

GBMs are known for their high accuracy and flexibility, making them suitable for a wide range of applications, including finance, marketing, and healthcare. They are particularly effective in handling complex datasets with many features and interactions. Popular implementations of Gradient Boosting Machines include XGBoost, LightGBM, and CatBoost, which offer efficient and scalable solutions for large-scale machine learning tasks.

Stacking involves training multiple models (often called base learners) and then using another model (meta-learner) to combine their predictions. The meta-learner typically takes the outputs of the base learners as input features to make the final prediction.

The Ensemble learning may also implement Support Vector Machines (SVMs) to classify data. SVMs are a powerful set of supervised learning algorithms used for classification and regression tasks. The goal is to find the optimal hyperplane that best separates the data points of different classes in a high-dimensional space.

### Example Computer Embodiment

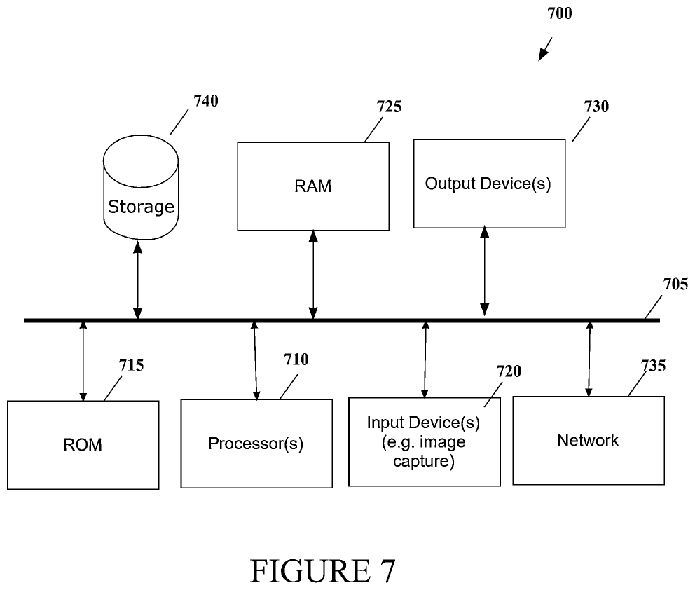

FIG. 7 illustrates an exemplary a system 700 that may implement the system. The electronic system 700 of some embodiments may be a mobile apparatus. The electronic system includes various types of machine readable media and interfaces. The electronic system includes a bus 705, processor(s) 710, read only memory (ROM) 715, input device(s) 720, random access memory (RAM) 725, output device(s) 730, a network component 735, and a permanent storage device 740.

The bus 705 communicatively connects the internal devices and/or components of the electronic system. For instance, the bus 705 communicatively connects the processor(s) 710 with the ROM 715, the RAM 725, and the permanent storage 740. The processor(s) 710 retrieve instructions from the memory units to execute processes of the invention.

The processor(s) 710 may be implemented with one or more general-purpose and/or special-purpose processors. Examples include microprocessors, microcontrollers, DSP processors, and other circuitry that can execute software. Alternatively, or in addition to the one or more general-purpose and/or special-purpose processors, the processor may be implemented with dedicated hardware such as, by way of example, one or more FPGAs (Field Programmable Gate Array), PLDs (Programmable Logic Device), controllers, state machines, gated logic, discrete hardware components, or any other suitable circuitry, or any combination of circuits.

Many of the above-described features and applications are implemented as software processes of a computer programming product. The processes are specified as a set of instructions recorded on a machine readable storage medium (also referred to as machine readable medium). When these instructions are executed by one or more of the processor(s) 710, they cause the processor(s) 710 to perform the actions indicated in the instructions.

Furthermore, software shall be construed broadly to mean instructions, data, or any combination thereof, whether referred to as software, firmware, middleware, microcode, hardware description language, or otherwise. The software may be stored or transmitted over as one or more instructions or code on a machine-readable medium. Machine-readable media include both computer storage media and communication media including any medium that facilitates transfer of a computer program from one place to another. A storage medium may be any available medium that can be accessed by the processor(s) 710. By way of example, and not limitation, such machine-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Also, any connection is properly termed a machine-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects machine-readable media may comprise non-transitory machine-readable media (e.g., tangible media). In addition, for other aspects machine-readable media may comprise transitory machine-readable media (e.g., a signal). Combinations of the above should also be included within the scope of machine-readable media.

Also, in some embodiments, multiple software inventions can be implemented as sub-parts of a larger program while remaining distinct software inventions. In some embodiments, multiple software inventions can also be implemented as separate programs. Any combination of separate programs that together implement a software invention described here is within the scope of the invention. In some embodiments, the software programs, when installed to operate on one or more electronic systems 700, define one or more specific machine implementations that execute and perform the operations of the software programs.

The ROM 715 stores static instructions needed by the processor(s) 710 and other components of the electronic system. The ROM may store the instructions necessary for the processor(s) 710 to execute the processes provided by the system. The permanent storage 740 is a non-volatile memory that stores instructions and data when the electronic system 700 is on or off. The permanent storage 740 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer.

The RAM 725 is a volatile read/write memory. The RAM 725 stores instructions needed by the processor(s) 710 at runtime, the RAM 725 may also store the real-time video or still images acquired by the system. The bus 705 also connects input and output devices 720 and 730. The input devices enable the user to communicate information and select commands to the electronic system. The input devices 720 may be a keypad, image capture apparatus, or a touch screen display capable of receiving touch interactions. The output device(s) 730 display images generated by the electronic system. The output devices may include printers or display devices such as monitors.

The bus 705 also couples the electronic system to a network 735. The electronic system may be part of a local area network (LAN), a wide area network (WAN), the Internet, or an Intranet by using a network interface. The electronic system may also be a mobile apparatus that is connected to a mobile data network supplied by a wireless carrier. Such networks may include 3G, HSPA, EVDO, and/or LTE.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other apparatuses, devices, or processes. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 18(f) unless the element is expressly recited using the phrase “means for” or, in the case of a method claim, the element is recited using the phrase “step for.”

Thus a method and apparatus for tracking crowd density has been described.

What is claimed is:

1. A method of monitoring a crowd comprising:
receiving data from a plurality of sensors;
analyzing the data;
determining crowd density based on the data;
determining if the crowd density in a location is above a predefined risk threshold;
taking mitigation measures to reduce the crowd density in that location when the crowd density is above the predefined risk threshold.

2. The method of claim 1 wherein the sensors comprise LiDAR sensors.

3. The method of claim 2 wherein the step of analyzing the data uses machine learning applied to the data.

4. The method of claim 3 where the predefined risk threshold is 5 persons per square meter.

5. The method of claim 4 wherein the mitigation measure comprises directing personnel to the location to reduce the crowd density at the location.

6. The method of claim 5 further including a step of determining if the mitigation measures reduced the crowd density below the pre-defined risk threshold.

7. The method of claim 6 wherein mitigation measures continue when the crowd density is not reduced below the pre-defined risk threshold.

8. The method of claim 1 wherein the step of analyzing the data uses a dynamic background model.

9. The method of claim 8 wherein the step of analyzing the data uses cluster detection.

10. The method of claim 9 wherein the step of analyzing the data uses object tracking.
